(19) United States
(12) Patent Application Publication
(10) Pub. No.: US 2021/0233674 A1
(43) Pub. Date: Jul. 29, 2021

(54) METHOD AND SYSTEM FOR FUSION DRIVE

(71) Applicant: HELICITY SPACE CORPORATION, San Francisco, CA (US)

(72) Inventor: Setthivoine YOU, San Francisco, CA (US)

(21) Appl. No.: 16/897,150

(22) Filed: Jun. 9, 2020

Related U.S. Application Data
(60) Provisional application No. 62/900,209, filed on Sep. 13, 2019.
(60) Provisional application No. 62/900,222, filed on Sep. 13, 2019.

(51) Int. Cl. G21B 1/05

(52) U.S. Cl. CPC G21B 1/05

(57) ABSTRACT

A fusion drive magnetically confining a plasma in a stable plectonemic minimum-energy Taylor states formed from the merging of a plurality of plectonemic Taylor states. Magnetic reconnection converts magnetic energy into ion heating to attain high temperatures before compression. The plasma configuration is then compressed to net gain in a peristaltic magnetic nozzle arrangement. The fusion drive supports generation of electrical power with inductive direct electric or thermal conversion methods.

### CROSS-REFERENCE TO RELATED APPLICATIONS

The present application claims priority to U.S. Provisional Application 62/900,209, filed on Sep. 13, 2019, and to U.S. Provisional Application 62/900,222, filed on Sep. 13, 2019, which are incorporated herein by reference in their entirety.

### BACKGROUND

### 1. Field

The present disclosure relates to fusion energy creation. More particularly, the present disclosure relates to a method and system for fusion energy creation that may be used for space propulsion or electric power generation.

### 2. Description of Related Art

Fusion energy has applications for space propulsion and high-power space and terrestrial energy, once fusion breakeven is achieved. Conventional approaches for thermonuclear fusion include two opposing approaches: Magnetic Confinement Fusion (MCF) and Inertial Confinement Fusion ICF). MCF uses strong magnetic fields to stabilize the plasma over long time scales, which requires steady-state heating methods to maintain the plasma temperature against cooling losses. However, steady-state heating methods, such as ohmic, radio-frequency, or neutral beam injection are massive and electrically inefficient. ICF uses rapid shock compression of the fuel to heat to fusion temperatures before instabilities break up the plasma, but compression drivers (lasers and X-rays) are massive and electrically very inefficient. In both MCF and ICF cases, the fusion gain Q must be very large to recoup all the power to the system. In space applications, massive radiators must also reject the waste heat, which reduces overall power.

Intermediate approaches have also been considered, which take a hybrid approach between MCF and ICF. These approaches known as magnetized target fusion (MTF) or magneto-inertial fusion (MIF) use combinations of magnetic fields and inertia to adiabatically compress a magnetized plasma target with imploding solid, liquid, plasma, or magnetic liners. But dynamic compression with imploding liners suffers from 3D instabilities that dramatically reduces compression and heating efficiency.

For space propulsion, a magneto-inertial pulsed approach balances an intermediate confinement time with compressive heating and may present the most rapid, economic, and feasible approach to practical fusion propulsion. An example approach in this category for fusion propulsion includes the flow-shear stabilized Z-pinch approach, which has recently achieved significant triple products and thermonuclear reactions with existing pulsed power systems at modest cost. Still another approach is the Pulsed Fission-Fusion (PuFF) engine Z-pinch approach, which uses a solid pellet mix of fissile and fusion fuel that reduces the driving power and mass required to reach fusion conditions, resulting in potentially very high specific powers.

However, these fusion approaches still exhibit concerns regarding compression ratios, stability, and radiation losses. Therefore, there still exists a need in the art for a method and system for fusion power that may be used for space propulsion or space or terrestrial power generation.

### SUMMARY

Described herein are according to embodiments of the present invention that provide for a method and system for fusion drive.

One embodiment is a method for fusion energy generation comprising: forming a plurality of magnetic plectonemes from a plurality of plasma sources; merging the plurality magnetic plectonemes into a single magnetic plectoneme; compressing the single magnetic plectoneme to provide ignited plasma; and, exhausting the ignited plasma.

Another embodiment is a fusion drive comprising a mounting structure having a mounting end, and an exhaust end; an interior disposed within the mounting structure, wherein the interior is disposed between the mounting end and the exhaust end, wherein the interior is defined by a first wall and the interior comprises: a tapered cylindrical converging section disposed near the mounting end, a tapered cylindrical diverging section disposed near the exhaust end; and a cylindrical stagnation section disposed between the tapered cylindrical converging section and the tapered cylindrical converging section; a blanket disposed around at least a portion of the interior; a plurality of plasma sources mounted at the mounting end, wherein the plurality of plasma sources generate a plurality of magnetic plectonemes and wherein each plasma source is configured to form at least one magnetic plectoneme within the tapered cylindrical converging section; a plurality of magnetic coils disposed around at least a portion of the interior, wherein the plurality of magnetic coils are configured to generate magnetic fields to merge the plurality of magnetic plectonemes to form a single magnetic plectoneme and to compress the single magnetic plectoneme to ignition; and a shield disposed around at least a portion of the plurality of magnetic coils. The exhaust end may be capped or uncapped.

Another embodiment is a system for a fusion drive comprising: a converging volume, wherein a plurality of magnetic plectonemes are formed within the converging volume, a stagnation volume having a first end and a second end, wherein the first end of the stagnation volume is coupled to the converging volume, wherein the plurality of magnetic plectonemes are merged into a single magnetic plectoneme at the first end of the stagnation volume and wherein the single magnetic plectoneme is compressed within the stagnation volume to provide ignited plasma for exhaustion at the second end of the stagnation volume; a diverging volume coupled to the second end of the stagnation volume, wherein the ignited plasma is exhausted through the diverging volume.

### BRIEF DESCRIPTION OF THE SEVERAL VIEWS OF THE DRAWINGS

FIG. 1 depicts magnetic fields arranged in a plectonemic shape inside a cylindrical volume boundary.

FIG. 2A illustrates magnetic reconnection.

FIG. 2B illustrates heating of plasma from magnetic reconnection processes.

FIG. 3A shows a front end of a fusion drive.

FIG. 3B shows a side view of the fusion drive.

FIG. 3C shows an isometric view of the fusion drive.

FIG. 4A shows the formation process in the fusion drive.

FIG. 4B shows the merging process in the fusion drive.

FIG. 4C shows the compression process in the fusion drive.

FIG. 4D shows the exhaust process in the fusion drive.

FIG. 5 shows a Lawson diagram which illustrates the conditions for achieving net fusion energy gain with the fusion drive.

FIG. 6 shows the effect of the compression step on the performance of the fusion drive.

FIG. 7A illustrates the triple product performance scaling with regard to the number of plectonemes.

FIG. 7B shows a fusion drive with N=19 plasma guns that form N=19 plectonemes.

FIG. 7C shows a graph of the scaling of total input energy with the number of plectonemes, with all other parameters remaining constant.

FIG. 8 shows an energy flow diagram for the fusion drive in an application as a fusion-augmented electric thruster.

FIG. 9 shows an energy flow diagram for the fusion drive in an application for fusion propulsion.

FIG. 10 shows an energy flow diagram for the fusion drive in an application for self-sustained fusion propulsion.

FIG. 11 shows an energy flow diagram for the fusion drive in an application for fusion propulsion and electrical power generation.

FIG. 12 shows an energy flow diagram for the fusion drive in an application for fusion-augmented electrical power generation with no propulsive power.

FIG. 13 shows an energy flow diagram for the fusion drive in an application for fusion electrical power generation with no propulsive power.

FIG. 14 shows an energy flow diagram for the fusion drive in an application for self-sustained fusion electrical power generation with no propulsive power.

### DETAILED DESCRIPTION

In the following description, for the purposes of explanation, numerous specific details are set forth in order to provide a thorough understanding of the present invention. It will be apparent, however, that embodiments of the present invention may be practiced without these specific details. In other instances, well-known structures and devices are shown in block diagram form in order to avoid unnecessarily obscuring the present invention. Embodiments of the present invention are described briefly immediately below and in expanded detail later in this disclosure. For clarity purposes, a definition section is included at the end of this detailed description for some of the terms used below in describing embodiments of the present invention. Additionally, a table of references is also included at the end of this detailed description for references cited in the description below.

The method and system of the present invention utilize magnetic reconnection and passive magnetic compression to control heating and density, which allows for the elimination of auxiliary heating systems and dynamic liners. Reconnection-heating transfers energy directly to ions, does not require unrealistic perfect shapes, operates sufficiently rapidly to leave electrons cool and reduce radiation losses, and the temperature gain scales as the square of the reconnecting magnetic field as described by Yamada, et al. [1], and Ono et al. [2]. The use of advanced fuels for fusion can therefore be considered in short pulses.

Passive constant-energy compression (CEC) with magnetic fields (a.k.a. peristaltic magnetic compression) uses a tapered arrangement of coils with travelling current pulses that, in effect, results in a magnetic mirror imploding symmetrically in 3D without the use of dynamic liners and without increasing driver energy. (See Bellan [4] and Bellan [5]) This approach requires a stable plasma able to travel at high velocity through the taper. A candidate configuration for this approach is a plectonemic magnetic configuration, which has been demonstrated experimentally to be stable without solid walls, to achieve high flow velocities, and to be robust to fast translations. See, for example, Cothran, et al. [6], and Lavine [8].

An embodiment of the present invention utilizes magnetic reconnection-heating and peristaltic magnetic compression to control temperature and density of a stable plasma plectonemic configuration to net energy gains in a short pulse. This embodiment may be considered as a magnetic four-stroke fusion engine with a reconnection-heating spark. Artsimovich [14], Haught et al. [15], Moir [16], and Oliphant et al. [17] describe a magnetic compression-expansion direct energy converter. However, these early concepts do not exploit magnetic reconnection, stable self-pinching, and a suitably stable plasma target. The four strokes of an embodiment of the present invention begin with the formation of several low-temperature plectonemes (process I), that merge into a denser, hotter final single plectoneme (process II), and compresses to fusion conditions with a constant-energy compression (CEC) scheme (process III). Electrical power can be generated from inductive or capacitive direct electric conversion, like the Artsimovich [14] or Oliphant et al [17] concept, and/or via conventional thermal conversion as the trapped plasma travels down the nozzle. Each process of this embodiment is described in additional detail below.

Process I: Formation of Plectonemes.

A plectoneme is an m=1 non-axisymmetric Taylor state [10] resembling a twisted, double-helical (i.e., plectonemic) ribbon inside a cylindrical magnetic flux conserving boundary with normalized eigenvalue λ̅=|λα|>3.1, where α is the radius of the cylinder, and λ=μ₀I/ψ is the ratio of current I to magnetic flux ψ with permeability μ₀. As noted above, the plectonemic magnetic configuration has been described by Cothran, et al. [6], and Lavine [8]. The m=1 configuration is energetically more favourable than an axisymmetric m=0 Taylor state (i.e., a spheromak as first described by Rosenbluth et al. [18] or see Bellan [19] textbook for an overview of spheromaks) in a cylindrical volume with a length-to-radius aspect-ratio L/α>1.67. An infinite length cylinder solution has λ̅=3.11. The name plectoneme comes from the mathematical study of DNA supercoils, as described for example by Boles [13]. The plectonemic configuration was theoretically predicted in magnetized plasmas by Bondeson, et al. [20] and Finn, et al. [21]. The configuration was first observed experimentally in solid wall volumes with aspect-ratio ≥3 (the SSX experiment, described by Cothran, et al. [6] and Gray, et al. [7]) and inside a helical-shear-flow-stabilized screw pinch without solid walls with aspect-ratio ≥25 (shown in the MOCHI experiment, described by Lavine [8] and Lavine et al. [9]).

In the MOCHI experiment, the overall configuration measures ˜1 m long with <5 cm radius and consists of a current-carrying magnetic sheath (skin of the jet) enclosing a rotating plectoneme (core of the jet). Helical shear flows stabilize the overall configuration to classical kink and sausage instabilities for >40 Alfvén times until power runs out, as described by Lavine, et al. [16]. The plasma density is 10²² m⁻³ with 60-80 kA core currents and 100-120 kA skin currents with 5-20 eV temperatures and measured magnetic fields 0.3-0.5 T. The normalized thermal energy density β=nT/B² is expected to be low from force-free Taylor state arguments. However, experimental measurements give β˜0.1 in the SSX experiment (see Cothran [6]) and β˜1 in the MOCHI experiment (see You, et al. [11]) suggesting that plectonemes can span a wide range plasma β.

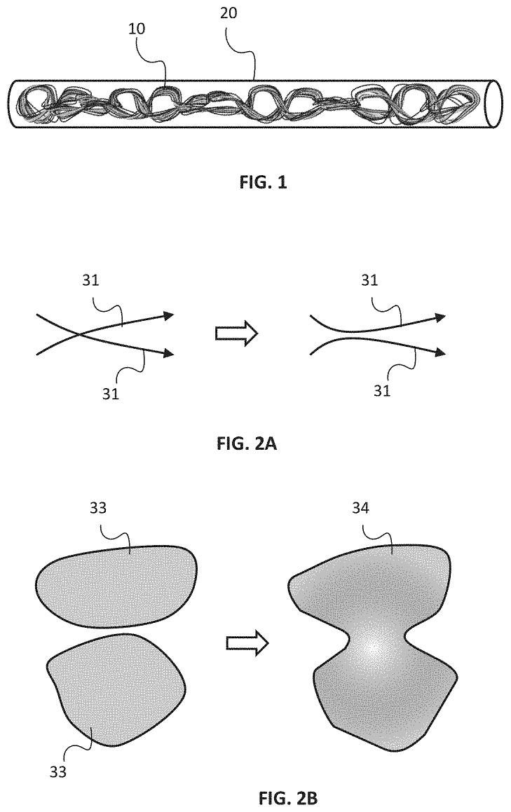

FIG. 1 depicts magnetic fields 10 arranged in a plectonemic shape inside a cylindrical volume boundary 20. In this description, “plectoneme” is used to describe the specific plasma configuration according to an embodiment of the present invention. Other magnetic confinement configurations known in the art include tokamaks, spheromaks, field-reversed configurations, stellarators, Z-pinches, screw pinches, and reversed field pinches. In FIG. 1, the shaded lines represent individual magnetic field lines and are calculated from Taylor's equation for the aspect of the MOCHI device. See Lavine [8] and You [11] for a description of the MOCHI device.

Process II: Reconnection-Heating.

Magnetic reconnection is a process that annihilates and changes the arrangement of magnetic field lines as described by Yamada et al. [1]. This process results in rapid conversion of magnetic energy into heat, with several model candidates for explaining this intrinsic mechanism (see Yoon et al. [22, 23] for stochastic interactions, see Ono et al. [2] for shocks and viscosity, see Shibata et al [24] and Matthaeus [25] for turbulent interactions, see Fiksel et al. [26] for fluctuating electric fields or see Yoo et al. [27] for remagnetization). Experiments that merge several compact toroids show that dissipated magnetic energy is efficiently and rapidly converted into ion thermal energy, as described by Ono et al. [2] [28]. About 90% of the reconnected magnetic energy is deposited into ion temperature, with ˜10% into electron temperature, on fast reconnection time scales, as described by Ono et al. [2].

FIG. 2A illustrates magnetic reconnection. The left half of FIG. 2A shows magnetic field lines 31 that cross each other. In the right half of FIG. 2A, the magnetic field lines 31 that cross are shown to connect, annihilate and rearrange into a new arrangement. FIG. 2B illustrates heating of plasma from magnetic reconnection processes. The left half of FIG. 2B shows two (or more) magnetic configurations 33 containing cool plasma that come into contact. The right half of FIG. 2B shows that magnetic reconnection transforms the multiple magnetic configurations 33 into a single magnetic configuration object 34. The magnetic reconnection processes convert some of the magnetic energy into heating of the plasma.

Temperature rise occurs with compact torus merging (as shown in the MAST and TS-series of experiments, described by Ono et al [2]), scaling as the square of the reconnected magnetic field strength. Results demonstrate MW-level heating with reconnection. Ion temperatures Tᵢ˜2.3 keV in a spherical tokamak purely from merging-reconnection formation are described by Gryaznevich et al. [12]. SSX experiments have observed Tᵢ rise from ˜10 eV to ˜100 eV using end-to-end merging of two plectonemes, as described by Brown et al. [3]. In the absence of a complete theory for reconnection-heating, we model from energy balance and supposing no loss of particles, the expected temperature rise for a species σ from magnetic reconnection as shown in Eq. 1 below:

ΔT_{σ}=f_{σ}ΔW_{mag}/n₂ (1)

where f₁=0.9 (fₑ=0.1) is the fraction of dissipated magnetic energy ΔW_{mag} deposited into ion (electron) thermal energy, respectively. Eq. 1 tracks to the experimental results shown by Ono et al. [2], where the dissipated (reconnected) magnetic field is presumed to be the poloidal field of the toroids in the data set. For non-axisymmetric plectonemes, where reconnection is even more complex to observe, the amount of dissipated magnetic field can be estimated with helicity conservation concepts. Helicity concepts are described by Woltjer [29] and Bellan [19].

An isolated Taylor state has an amount of helicity K given by λ=2μ₀ W_{mag}/K where W_{mag} is the magnetic energy, μ₀ is the permeability of free space and λ is the eigenvalue of the Taylor state. Supposing several Taylor states are injected into the system, the initial helicity content is Kᵢₙᵢₜ=ΣKⱼ and the initial magnetic energy content is W_{maginit}=ΣW_{magj} when summing over N_{plec} objects and the system has an initial lambda λᵢₙᵢₜ=(2μ₀ W_{maginit})/Kᵢₙᵢₜ. If kᵢₙᵢₜ is larger than the lambda eigenvalue (minimum energy lambda of the flux conserving boundary) then the system will dissipate the free magnetic energy to transition to a λ_{final} while preserving helicity. The dissipated energy is ΔW_{mag}=W_{maginit}−W_{magfinal}, so the dissipated may be shown by Eq. 2 below:

ΔW_{mag}=W_{maginit} (1−λ_{final}/λᵢₙᵢₜ) (2)

assuming helicity is conserved.

The experimental λ is related to the Taylor state eigenvalue λ̅ by a geometric factor, say the radius α of the flux conserver, such that λ̅=λ×α. Therefore, combining Eqs. 1 and 2, if the final Taylor state after reconnection has the same λ̅_{final}=λ̅ᵢₙᵢₜᵢₐₗ then the temperature of state 2 after reconnection-merging of N_{plec} identical plectonemes is as shown in Eq. 3 below:

$${T}_{σ 2} = {T}_{σ2 i nit} + \frac{{f}_{σ}}{{n}_{2}} ( 1 - \frac{{a}_{2 init}}{{a}_{2}} ) {\sum }_{j}^{{N}_{p l e c}} {W}_{m a g 1 j} \qquad Eq . 3$$

where the state 2 density is n₂=Σⱼ^{N}^{_{plec}}n₁ⱼV₁ⱼ/V₂ summed over the density n₁ⱼ and volumes V₁ⱼ of state 1 plectonemes, and the state 2 initial temperature is the average T₂ᵢₙᵢₜ=T₁₁ V₂/V₁₁ (taking j=1).

Magnetic reconnection-merging occurs, if the flux conserving volume of state 2 increases in the geometric factor α. This property allows control of the amount of magnetic energy converted to heat by selecting the size of the flux conserving volume before and after reconnection. From energy balance, the change in the magnetic field is shown by Eq. 4 below:

$${B}_{2}^{2} = {\sum }_{i}^{{N}_{p l e c}} {B}_{1 i}^{2} ( \frac{〈 {a}_{1} 〉}{{a}_{2}} + \frac{{a}_{i}^{2} {L}_{i}}{{a}_{2}^{2} {L}_{2}} - 1 ) \qquad Eq . 4$$

where α₂ᵢₙᵢₜ= [symbol] α₁ [symbol] is the average radius of the identical plectonemes in state 1.

The average magnetic energy per particle B²/n=T/βremains approximately the same after reconnection (assuming a small change in flux conserving volume) but the average thermal energy per particle T_{σ}/β (where β=βᵢ+βₑ) will differ by Tᵢ/Tₑ. Reconnection-heating, in effect, redistributes the average magnetic energy per particle to favor the average ion thermal energy content. This is an advantage for a fusion reactor where breakeven conditions need an average ion thermal energy to be greater than the ignition temperature T_{ign}/β. The state 2 magnetic field scales as \sqrt{N_{plec}}, the temperature rise does not depend on N_{plec}, and density scales as N_{plec} so it may be possible to control the increase in plasma β and control B²/n simply with the number of merging objects and initial magnetic energy. This lowers the power requirements for each initial object and provides scalability, analogous to the number of cylinders of internal combustion engines.

Process III: Compression to Ignition

To achieve breakeven, the triple product, shown in Eq. 5, should be maximized:

n T τ=β B² τ (5)

where β=nT/B², using the CEC process from state 2 to state 3. The CEC method employs a passive arrangement of magnetic coils to compress the plasma in 3D without dynamic liners at a constant magnetic field energy. Bellan [4,5] describes the CEC process. It is, in effect, a spontaneously imploding magnetic mirror with a compression ratio solely determined by system geometry and not by energy input. This scheme is more efficient than rapidly increasing coil currents because magnetic energy scales as B² and particle energy scales as T_{⊥}∝B, so solely increasing coil currents means more energy goes into creating new field lines than into heating particles. In the CEC scheme, the magnetic field scales as B∝m^{1/2}Δ^{-3/4}r^{-1/2} where m is the number of turns in a coil, Δ is the distance separating adjacent coils, and r is the coil radius. Sending a double-hump current pulse into a tapered coil arrangement with smoothly varying m, Δ, r creates a travelling magnetic mirror with gradually increasing mirror fields. A delay-line arrangement for the coils slows the travelling current pulse in the tapering setup, shortening the axial extent of the mirror Λ∝m⁻¹Δ^{3/2}r⁻¹ to complement the radial compression. Various combinations of m, Δ, r can be used, such as Δ=m^{2/3}r^{2(c-1)/3} so that B∝r^{-c/2}, Λ∝r^{c-2}, n∝r^{-c}, T∝r^{-c(γ-1)}, β∝t where c is a numerical constant determined by the coil arrangement and γ is the polytropic constant. For example, the compression is at constant flux for c=4, constant geometry at c=3, and constant for T_{⊥}/T_{∥}for c=8/3.

The average magnetic energy per particle B²/n is unchanged during CEC compression (no new magnetic field lines are created). The final plasma in State 3 after compression is assumed to have a known plasma beta β₃ at a known target ignition temperature T₃=T_{ign}, where T_{ign} is the ignition temperature when alpha self-heating power becomes larger than power losses. Since

B²/n=T/β=T_{ign}/β₃, state 2 must already have the minimum average magnetic energy per particle for ignition, for example B₂²/n₂=10 keV/particle for T_{ign}=10 keV and β₃=1.

With the CEC scaling, Eq. 5 for state 3 is shown as Eq. 6 below:

n₃T₃τ₃=β₃B₂²rₙτ₃ (6)

which expresses the triple product of state 3 in terms of target and operator parameters (B₂ is given by Eq. 4). The compression ratio rₙ=n₃/n₂ is determined by the temperature or beta ratio as shown in Eq. 7 below:

$${n}_{3} / {n}_{2} = {( {T}_{3} / {T}_{2} )}^{\frac{1}{γ - 1}} = {( {β}_{3} / {β}_{2} )}^{\frac{1}{γ - 1}} \qquad Eq . 7$$

between states 2 and 3. Assuming the confinement time follows Bohm scaling τ=α²/D_{Bohm}, so the confinement time τ for state 3 is shown by Eq. 8 below:

$${τ}_{3} = 16 {a}_{2}^{2} {B}_{2} {r}_{n}^{\frac{3}{2} - γ - \frac{2}{c}} / {T}_{2} \qquad Eq . 8$$

and the tripling product scaling shown in Eq. 6 becomes as shown in Eq. 9 below:

$${n}_{3} {T}_{3} {τ}_{3} [ k e V {m}^{- 3} s ] = \frac{{μ}_{0}}{2 {π}^{2} \times 1 {0}^{3} e} {β}_{3} {N}_{p l e c} {I}_{11}^{2} {a}_{2} {B}_{2} {r}_{n}^{\frac{5}{2} - γ - \frac{2}{c}} / ( {a}_{11} {T}_{2} ) \qquad Eq . 9$$

Using Eqs. 3 and 4, Eq. 9 shows that the triple product nTτ∝N_{plec}^{3/2}I₁₁n₁₁α₁₁rₙ^{5/6-2/c}. Increasing the number of plectonemes reduces the requirements of individual plasma guns and compression ratio.

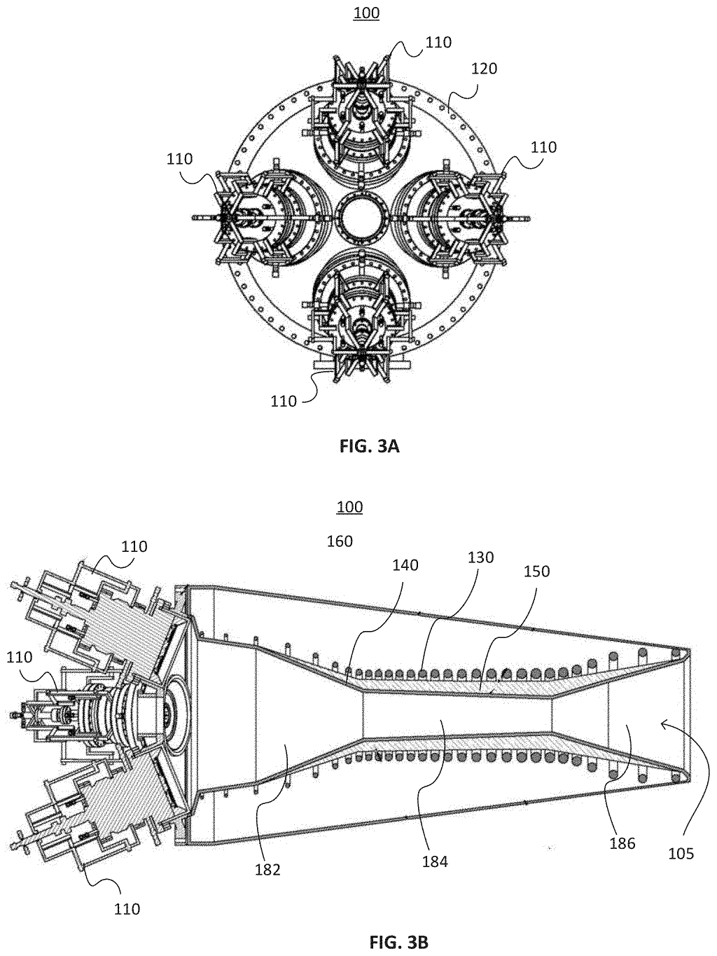

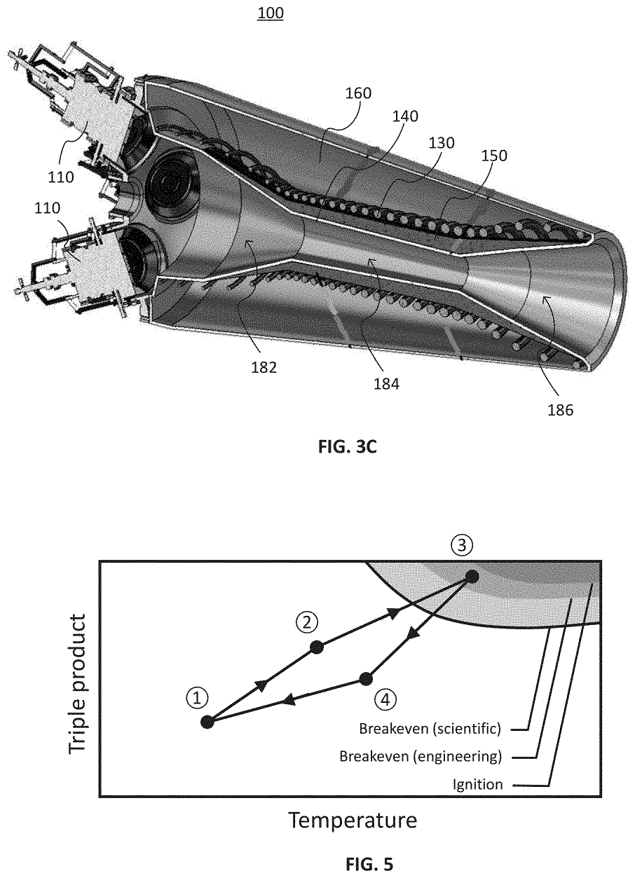

FIGS. 3A-3C illustrate an embodiment of the present invention adapted as a fusion drive. FIG. 3A shows a front view of the fusion drive 100, where the front of the fusion drive 100 is opposite an exhaust end of the fusion drive 100. FIG. 3A shows multiple plasma guns 110 mounted on the fusion drive structure 120, where the plasma guns are oriented to direct plasma into the interior 180 of the fusion drive 100. FIG. 3B shows side view of the fusion drive. FIG. 3B shows a first wall 140 surrounding the interior 105, where the first wall 140 is a plasma facing surface. Magnetic coils 130 encircle the first wall 140. Shielding 150 may be disposed between the first wall 140 and the magnetic coils 130. A thermal blanket 160 may be disposed around the first wall 140, shielding 150, and magnetic coils 130 to provide appropriate thermal control and extract heat deposited in the blanket by capture of neutrons originating from thermonuclear fusion processes). In FIG. 3B, the tapered nozzle inlet 182 is the converging section of the fusion drive 100. The tapered burning volume 184 is the stagnation section of the fusion drive 100 and the tapered nozzle outlet 186 is the diverging section of the fusion drive 100. FIG. 3C shows an isometric view of the fusion drive 100.

The embodiment depicted in FIG. 3 is a fusion reactor with a method of operation configured to create conditions that can enable controlled thermonuclear fusion reactions in a short pulse with net gain and scalable performance. The output energy can be converted to propulsive energy for in-space applications or electrical energy for power plant applications.

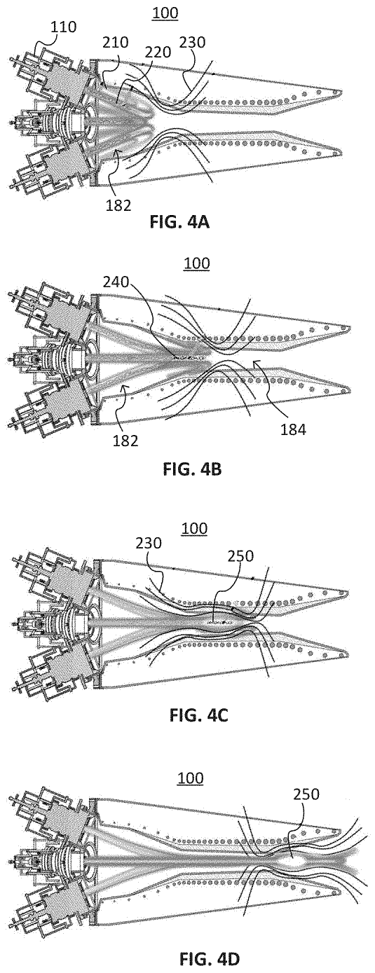

FIGS. 4A-4D depict the four sequential processes performed by the fusion reactor during each pulse of its pulsed operation, where the four processes are: (1) Formation; (2) Merging; (3) Compression; and (4) Exhaust.

FIG. 4A shows the formation process in the fusion drive 100. As shown in FIG. 4A, plasma guns 110 provide plasma jets 210. A cold magnetic plectoneme 220 is embedded in each plasma jet 210. Typically, one plectoneme 220 is formed per plasma jet 210 (plasma source). The magnetic plectonemes 220 are injected into the nozzle inlet section 182 of the fusion drive 100. Peristaltic magnetic mirror lines 230 are shown in FIG. 4A, where the front of the lines 230 are in front of the plectonemes 220.

FIG. 4B shows the merging process in the fusion drive 100. The cold magnetic plectonemes 220 merge to form a single hot magnetic plectoneme 240. The new single hot magnetic plectoneme 240 is heated to a high temperature via a reconnection-heating process (as described above) during this merging process. This merging process occurs at the transition between the nozzle inlet section 182 and the burning volume section 184 of the drive fusion 100.

FIG. 4C shows the compression process in the fusion drive 100. The single hot magnetic plectoneme 240 is compressed with external magnetic fields, using a constant energy compression (CEC) method (as described above). FIG. 4C shows the compressed plectoneme 250.

FIG. 4D shows the exhaust process in the fusion drive 100, where the compressed plectoneme 250 undergoes expansion. For space propulsion applications, traveling and expansion of the plectoneme against the diverging section of the external magnetic field produces thrust. The plectoneme may be mixed with cooler propellant, such as cooler plasma and/or neutral gas, to obtain an appropriate temperature and mass for the combined mix to achieve a desired value of exhaust velocity and thrust. In this application, the exhaust end is left uncapped to allow for the production of thrust. In other applications, such as power generation, the exhaust end may be capped.

The fusion drive 100 discussed may be used in power plant applications. In such applications, the burning plasma is carried forward in peristaltic fashion in a long stagnation section until all energy is dissipated. The fusion energy is output in the form of neutron kinetic energy, electromagnetic energy and charged particle energy. This energy can be converted to electrical power with a conventional thermal conversion process and/or a direct electric process.

The fusion drive 100 may be employed for both propulsion and power applications, by combining both the propulsion processes and the power generation processes described above. The combination can be changed as desired. For example, in a space application where propulsion is no longer needed (for example, upon arrival at destination), all energy can be directed towards generation of electrical energy, and vice versa (for example, for departure from the destination).

FIG. 5 shows a Lawson diagram which illustrates the conditions for achieving net fusion energy gain with the fusion drive discussed above. The triple product is graphed against plasma temperature at each step in the four-step process described above. This diagram shows that the fusion drive system operates in a cyclic manner. Each pulse from the drive undergoes the four processes to achieve net gain and exhaust at the appropriate temperature for efficient propulsion.

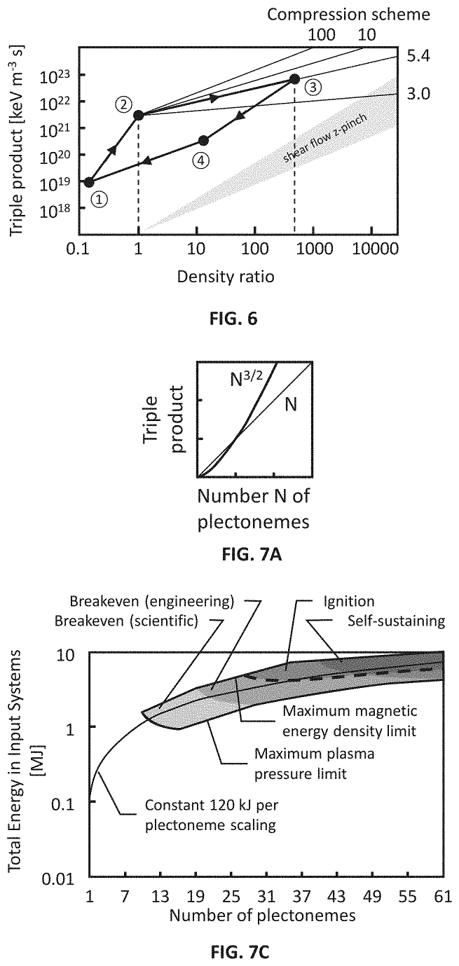

FIG. 6 shows the effect of the compression step on the performance of the fusion drive. The compression scheme is determined by the chosen coil geometry and electrical systems of the magnetic nozzle (as described above by the constant c where c is a numerical constant determined by the coil arrangement). In FIG. 6, the triple product is plotted against the density ratio for each step of the four-step process described above. As shown in FIG. 6, the triple product magnitude change from step 2 to step 3 can be increased by selecting the compression scheme (as described above by the constant c where c is a numerical constant determined by the coil arrangement). FIG. 6 also shows, in the shaded area, the scaling of the triple product for a shear flow Z-pinch fusion concept, as described by Shumlak et al [30] with confinement time scaling as the flow-through scaling (upper limit of shaded area) or Bohm scaling (lower limit of shaded area). The shaded area shows that the Z-pinch concept requires much greater density ratio compression from its adiabatic compression scheme to reach the same values of triple product, or conversely, the fusion drive discussed here requires less stringent compression to achieve the same values of triple product.

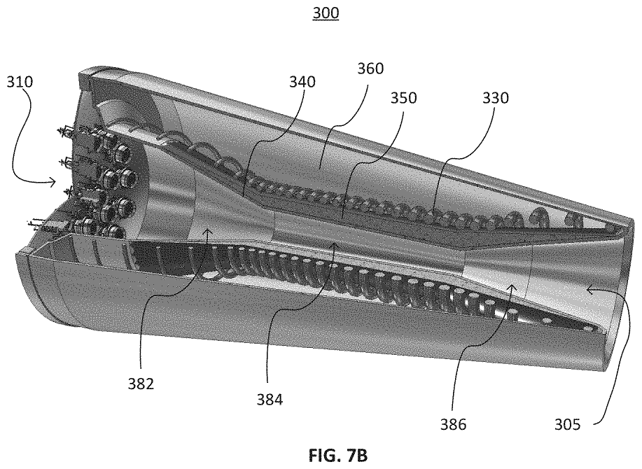

As briefly discussed above, increasing the number of plectonemes increases the fusion performance as N^{3/2} (where N is the number of plectonemes), while keeping constant the engineering parameters of each plasma gun. This is analogous to increasing the number of cylinders in a car engine, where engine horsepower scales with the number of cylinders. FIG. 7A illustrates the triple product performance scaling with regard to the number of plectonemes.

FIG. 7B shows a fusion drive 300 with N=19 plasma guns that form N=19 plectonemes. This figure shows that the general design of the fusion drive does not change significantly to accommodate additional plasma guns. FIG. 7B shows that the interior 305 of the fusion drive 300 comprises converging section 382, a stagnation section 384, and a diverging section 386. 19 plasma guns 310 are mounted on the fusion drive structure 320, where the plasma guns are oriented to direct plasma into the interior 305 of the fusion drive 300. A first wall 340 surrounds the interior 305. Magnetic coils 330 encircle the first wall 340. Shielding 350 may be disposed between the first wall 340 and the magnetic coils 330. A thermal blanket 360 may be disposed around the first wall 340, shielding 350, and magnetic coils 330 to provide appropriate thermal control for the fusion drive 300.

FIG. 7C shows a graph of the scaling of total input energy with the number of plectonemes, with all other parameters remaining constant. This graph shows that increasing the number of plectonemes simplifies approaching the net fusion gain regimes. Specifically, for the parameters chosen for the graph in FIG. 7C, breakeven may be obtained with 19 plectonemes, while the logarithmic increase in total input energy for self-sustaining fusion may be obtained with only 43 plectonemes.

A simple numerical model evaluated operation of the fusion drive using Deuterium-Deuterium (DD) fuel to Q=1. The model merged 8 plectonemes (each with 1.5×10²² m⁻³, 20 eV, 1.5 MA, 1 m length, 3.5 cm radius similar to MOCHI parameters) into a single plectoneme of 1 m length, 3.6 cm radius, heated by reconnection to Tᵢ˜340 eV, Tₑ˜60 eV , n˜10²³ m⁻³, B˜24 T with B²/n˜12 keV/particle and Tᵢ/β˜21 keV/ion and Tₑ/β˜3 keV/electron, assuming no loss of particles. Compression in the CEC magnetic nozzle with a density ratio of 400 at c=5.45 and γ=5/3 results in Tᵢ˜20 keV (without taking into account the benefit of self-heating), Tₑ˜3 keV, n˜5×10²⁵ m⁻³, β˜473 T at β=1 and a triple product nTτ˜6×10²² keV m⁻³ s with Bohm confinement time τ_{E}˜5×10⁻⁵ s at state 3. This triple product corresponds to Q≅1 for a burn time t_{burn}˜3×10⁻⁴ s of catalyzed-DD fuel or Q≅10 for Deuterium-Tritium (DT) fuel where the short pulse fusion gain is Q=P_{fus}t_{burn}/(3/2(nᵢTᵢ+nₑTₑ)+P_{rad}t_{burn}).

As discussed above, increasing N_{plec} reduces gun and compression engineering requirements for a similar triple product. For example, a net-gain experiment costing analysis uses 27 plasma guns that each produce a plectoneme with 1.5×10²² m^{-3, 20} eV, 760 kA core and skin currents, 2 cm radius and 1 m length, merging into a 2.2 cm radius, 1 m long single plectoneme, followed by a density compression ratio of 60 with a c=10 CEC compression scheme to obtain Q_{eng}=E_{fus}/E_{wall}˜10 with E_{wall}˜9.6 MJ total in a single shot. The triple product at stagnation is ˜3×10²² keV s m⁻³ assuming Bohm confinement time.

As briefly discussed above, the fusion drive described herein may be utilized in a number of different applications. FIGS. 8-13 show energy flow diagrams for various applications using the fusion drive described above. In these figures, the fusion energy is produced by the fusion reactor 500. The fusion energy produced by the fusion reactor 500 is distributed among different types of energy shown in the unshaded boxes in the figures. The fusion reactor 500 produces charged particles that have large kinetic energy 510, neutrons that have large kinetic energy 520, Bremmstrahlung-type of electromagnetic radiation energy 530 and synchrotron-type of electromagnetic radiation energy 540. A portion of the energy carried by the charged particles 510 may be absorbed by the first wall 610 or converted to electricity by direct electric conversion systems 970 or converted to thrust 900 with the propulsion conversion mechanism 720 described above and that has some direct propulsive loss 580. Energy carried by the neutrons 520 may absorbed by the first wall 610 and/or the blanket 620 of the fusion drive. Energy in the form of Bremmstrahlung radiation 530 may be absorbed by the first wall 610, the blanket 620, or the shielding 630 of the fusion drive. Energy from synchrotron radiation 540 may be absorbed by the blanket 620 or the shielding 630 of the fusion drive. All these absorptions of energy by the first wall 610, the shielding 630 and the blanket 620 can be converted to electricity using a conventional thermal conversion process 960. The fraction of energy that is not absorbed is accounted for as a total direct loss 550 and the fraction of energy that is not converted to electricity (waste energy) is directed to radiators 650. A power management apparatus 710 provides electric energy to the drivers for the plasma guns and magnetic coils and other smaller sub-systems 640 of the fusion drive. Waste thermal energy from the shielding 630, the power conversion systems 960 and 970 and auxiliary power system 700 and the drivers for the plasma guns and magnetic coils 640 is directed to radiators 650. All the waste thermal energy coupled to the radiators 650 is accounted for as total radiated energy 590.

FIG. 8 shows an energy flow diagram for the fusion drive in an application as a fusion-augmented electric thruster. In this application, the exhaust process of the fusion drive converts the available large charged particle energy 510, resulting from the fusion reactor 500, into large propulsive power 900 from propulsion conversion 720. Propulsion conversion 720 is naturally imperfect so also results in some propulsive loss 580. An auxiliary power source 700 is used to produce electric energy for the whole fusion drive which is managed by the power management apparatus 710. Waste thermal energy from auxiliary power source 700, the first wall 610 and the blanket is directed to the radiators 920. At fusion gain values above breakeven, the energy output from the fusion reactor 500, in effect, increases the overall efficiency of converting external auxiliary power from the auxiliary power source 700 into propulsive power. This propulsive power is unachievable directly from the auxiliary power source 700 with conventional electric thrusters.

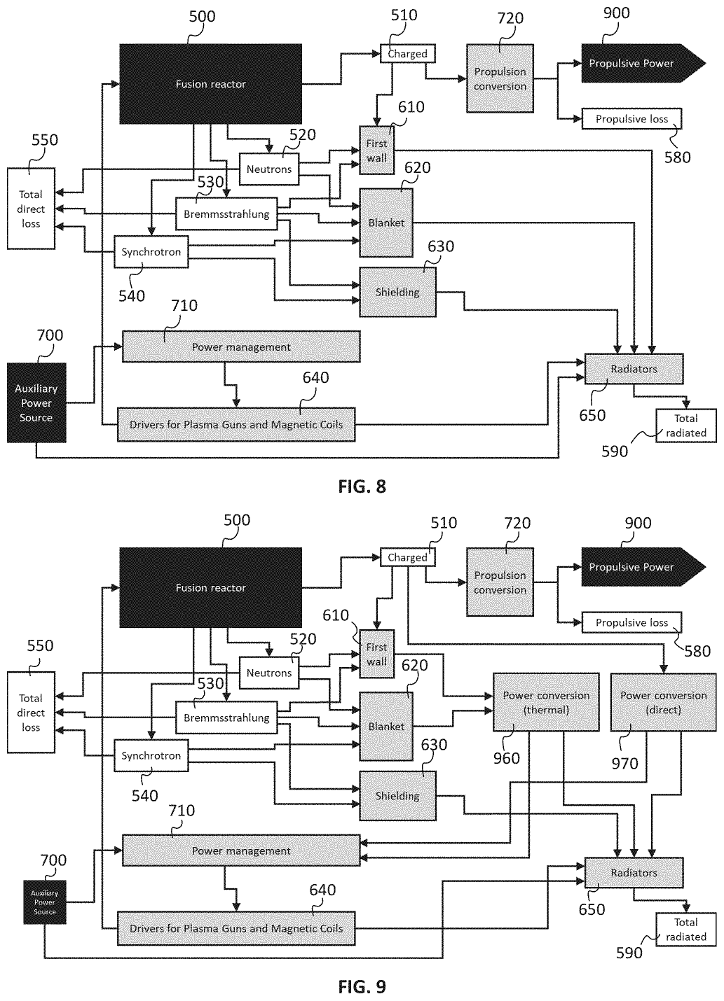

FIG. 9 shows an energy flow diagram for the fusion drive in an application for fusion propulsion at fusion gains between breakeven and self-sustained threshold. In this application, the exhaust process of the fusion drive converts the available large charged particle energy 510, resulting from the fusion reactor 500, into large propulsive power 900 from propulsion conversion 910 along with some propulsive loss 580. Thermal energy from the first wall 610 and the blanket 620 may be utilized for thermal power conversion 960 to electricity, which is then directed to the power management apparatus 710. A portion of the energy from the charged particles may also be directed to direct power conversion 970 to electricity, which is also directed to the power management apparatus 710. Waste thermal energy is directed to the radiators 650 from the thermal power conversion 960, the direct power conversion 970, and the auxiliary power source 700. At fusion gains between breakeven and self-sustained threshold, the fraction of fusion energy carried by neutrons 520 and/or charged particles 510 is partially sufficient to power the drivers 640 for the fusion reactor 500. The small auxiliary power source 700 complements the required input energy to the power management apparatus 710. The charged particles 510 carry the energy for propulsive power 900. Operational decisions can choose how much of the charged particle energy is converted to thrust and how much is converted to electrical power.

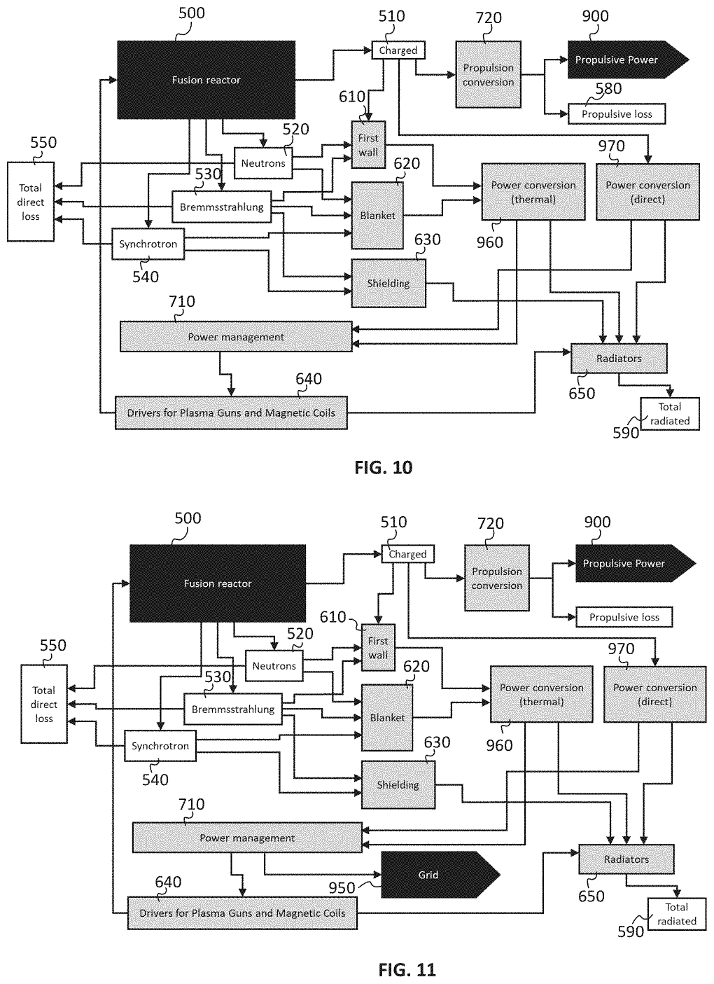

FIG. 10 shows an energy flow diagram for the fusion drive in an application for self-sustained fusion propulsion. In this application, the exhaust process of the fusion drive converts the available large charged particle energy 510, resulting from the fusion reactor 500, into large propulsive power 900 from propulsion conversion 910 along with some propulsive loss 580. Thermal energy from the first wall 610 and the blanket 620 is utilized for thermal power conversion 960 to electricity, which is then directed to the power management apparatus 710. A portion of the energy from the charged particles may also be directed to direct power conversion 970 to electricity, which is also directed to the power management apparatus 710. Waste thermal energy from the thermal power conversion 960 and the direct power conversion 970 is directed to the radiators 650. At fusion gains greater than self-sustained threshold, the fraction of fusion energy carried by neutrons 520 and/or charged particles 510 is sufficient to power the drivers 640 for the fusion reactor. The charged particles 510 carry the energy for propulsive power 900. Operational decisions can choose how much of the charged particle energy 510 is converted to thrust and how much is converted to electrical power. In this application, an auxiliary power source may not be required.

FIG. 11 shows an energy flow diagram for the fusion drive in an application for fusion propulsion and electrical power generation. In this application, the exhaust process of the fusion drive converts the available large charged particle energy 510, resulting from the fusion reactor 500, into large propulsive power 900 from propulsion conversion 910 along with some propulsive loss 580. Thermal energy from the first wall 610 and the blanket 620 may be utilized for thermal power conversion 960 to electricity, which is then directed to the power management apparatus 710. A portion of the energy from the charged particles may also be directed to direct power conversion 970 to electricity, which is also directed to the power management apparatus 710. The power management apparatus 710 may provide electrical power to an electrical grid 950 along with the drivers 640. Waste thermal energy from the thermal power conversion 960 and the direct power conversion 970 is directed to the radiators 650. At fusion gains greater than self-sustained threshold, the fraction of fusion energy carried by neutrons 520 and/or charged particles 510 is more than sufficient to power the drivers 640 for the fusion reactor 500. The excess energy can be sent to the grid 950 for other applications. The charged particles 510 carry the energy for propulsive power 900. Operational decisions can choose how much of the charged particle energy 510 is converted to thrust and how much is converted to electrical power. In this application, an auxiliary power source, even a small one, may not be required.

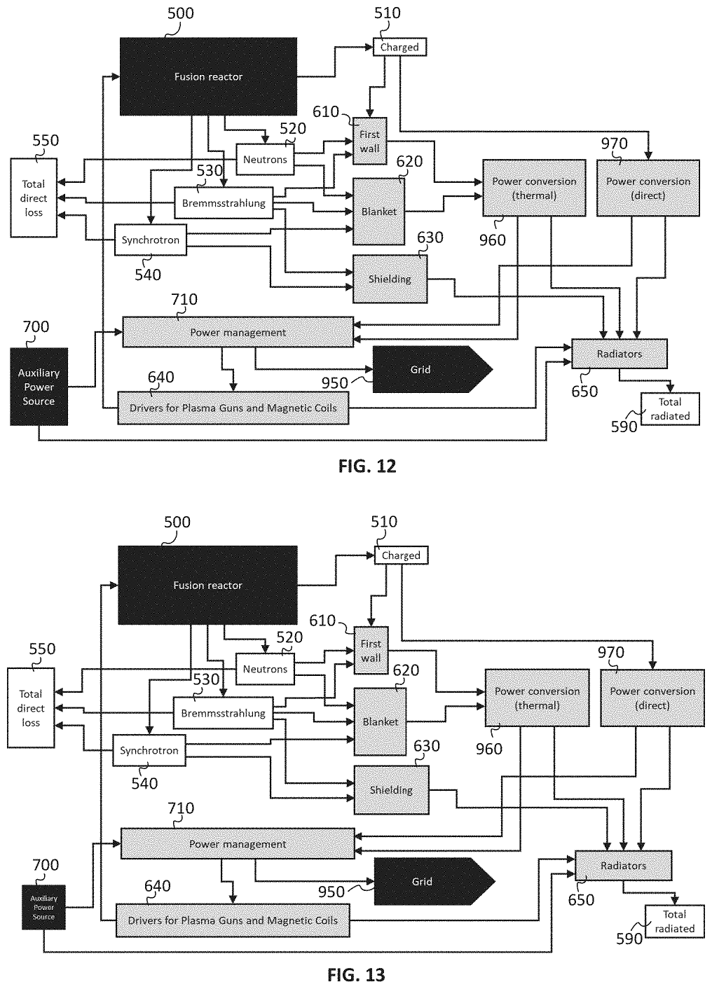

FIG. 12 shows an energy flow diagram for the fusion drive in an application for fusion-augmented electrical power generation with no propulsive power. In this application, the energy from the charged particles 510 is directed to direct power conversion 970 to electricity, which is directed to the power management apparatus 710. Thermal energy from the first wall 610 and the blanket 620 may also be utilized for thermal power conversion 960 to electricity, which is directed to the power management apparatus 710. An auxiliary power source 700 may also be used to provide complementary electrical energy to the power management apparatus 710. The power management apparatus 710 provides electrical power to an electrical grid 950 along with the drivers 640. Waste thermal energy is directed to the radiators 650 from the shields 630, the power management apparatus 710, the thermal power conversion 960, the direct power conversion 970, and the auxiliary power source 700. At fusion gain values above breakeven, the energy output from the fusion reactor 500 increases the overall efficiency of converting external auxiliary power from the auxiliary power source 700 into grid power 950.

FIG. 13 shows an energy flow diagram for the fusion drive in an application for fusion electrical power generation with no propulsive power. In this application, the energy from the charged particles 510 is directed to direct power conversion 970 to electricity, and subsequently directed to the power management apparatus 710. Thermal energy from the first wall 610 and the blanket 620 may also be utilized for thermal power conversion 960 to electricity, which is then directed to the power management apparatus 710. A small auxiliary power source 700 may also be used to provide complementary electrical energy to the power management apparatus 710. The power management apparatus 710 provides electrical power to an electrical grid 950 and to the drivers 640. Waste thermal energy is directed to the radiators 650 from the shields 630, the power management apparatus 710, the thermal power conversion 960, the direct power conversion 970, and the auxiliary power source 700. At fusion gains between breakeven and self-sustained threshold, the fraction of fusion energy carried by neutrons 520 and/or charged particles 510 is partially sufficient to power the drivers 640 for the fusion reactor 500. The small auxiliary power source 700 complements the required input energy. The excess energy can be sent to the grid 950 for other applications.

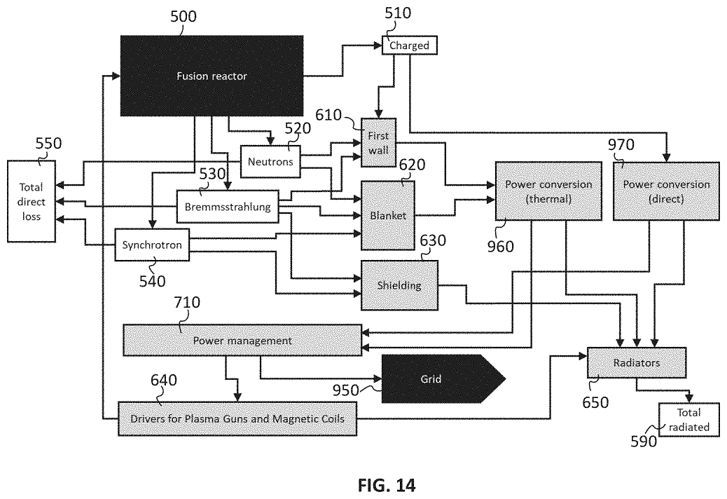

FIG. 14 shows an energy flow diagram for the fusion drive in an application for self-sustained fusion electrical power generation with no propulsive power. In this application, the energy from the charged particles 510 is directed to direct power conversion 970 to electricity, subsequently directed to the power management apparatus 710. Thermal energy from the first wall 610 and the blanket 620 may also be utilized for thermal power conversion 960 to electricity, which is then directed to the power management apparatus 710. The power management apparatus 710 provides electrical power to an electrical grid 950 and to the drivers 640. Waste thermal energy is directed to the radiators 650 from the shields 630, the power management apparatus 710, the thermal power conversion 960, the direct power conversion 970, and the auxiliary power source 700. At fusion gains greater than self-sustained threshold, the fraction of fusion energy carried by neutrons 520 and/or charged particles 510 is more than sufficient to power the drivers 640 for the fusion reactor 500. The excess energy can be sent to the grid 950 for other applications.

The fusion drive described above enables the ability to merge more than two plectonemes. In the fusion dive, the plasma sources may be triple-electrode magnetized plasma guns. The triple-electrode magnetized plasma guns can make stable plectonemes without close-fitting solid walls. These sources may be arranged is a circular pattern on one end of a singly connected volume (i.e., topologically equivalent to a sphere or cylinder). The sources may be slightly angled towards a common focal point to aid in the merging and compression processes in the fusion drive sequence.

Embodiments of the present invention contemplate pulsed operation, where the energy gain per pulse multiplied by the pulse frequency (and factoring in appropriate conversion efficiencies) gives the total overall power output of the fusion reactor. This pulsed operation supports scaling the fusion drive from operating as an in-space propulsion engine to fully ignited power plants (terrestrial or extra-terrestrial). Various operational scenarios may be used for each pulse. These scenarios include: (1) all sources are triggered simultaneously; (2) a subset of the sources is triggered on a rotating basis; or (3) a subset of the sources is triggered with a changing number of simultaneous sources.

The fusion drive described above provides several benefits. The fusion drive provides a fusion triple product that scales favorably with the number of plectonemes. The fusion drive design can scale from a fusion-augmented electrical propulsion system at lower number of plectonemes to a fully self-sustained fusion power plant and propulsion system at higher number of plectonemes. Higher pulse frequencies may be achieved with the fusion drive, and, therefore, overall reactor power output levels, without increasing power switching demands. The pulse frequency can be rapidly ramped up and down, and, therefore, overall reactor power output levels can be rapidly ramped up and down as desired. Engineering requirements and stresses on each plasma source are reduced. The fusion drive may require no solid or liquid moving parts, which simplifies the overall system (for example, liquid liners, solid liners, etc. may not be required). The fusion drive may not need other auxiliary heating systems (for example, neutral beam injection, radio-frequency resonant heating, etc.).

A number of embodiments of the disclosure have been described. Nevertheless, it will be understood that various modifications may be made without departing from the spirit and scope of the present disclosure. Accordingly, other embodiments are within the scope of the following claims.

List of Definitions

Plasma: ionized gas, typically made up of ions and electrons.

Magnetized plasma: a plasma that has internal, embedded magnetic fields.

Plectoneme: (from Ancient Greek for twisted thread) a twisted loop of helices. Often used to describe DNA shapes.

Magnetic plectoneme: magnetic fields arranged in a plectonemic shape. Here we use plectoneme as shorthand to describe our specific plasma confinement configuration (for comparison, other magnetic confinement configurations are called tokamaks, spheromaks, field-reversed configurations, stellarators, Z-pinches, screw pinches, reversed field pinches, etc.)

Taylor state: magnetic fields arranged according to Taylor's force-free equation that describes a relaxed magnetized plasma state. Examples of Taylor states are spheromaks, reversed-field pinches and magnetic plectonemes. Tokamaks, stellarators, Z-pinches, screw pinches are not Taylor states.

Magnetic reconnection: a natural process that annihilates and changes the arrangement of magnetic field lines.

Reconnection-heating: heating of plasma from magnetic reconnection processes.

Peristaltic: a wave-like contraction of tubular structure by which contents are forced onward toward an opening. For example, the muscular process of the digestive tract.

Peristaltic magnetic compression: compression of plasma using external magnetic fields in a peristaltic manner.

Magnetic mirror: a tubular magnetic field with inlet and outlet sections having stronger magnetic fields than in the middle section.

Constant energy compression (CEC): compression of plasma with an external peristaltic imploding mirror magnetic field using constant energy.

Ion: atomic nuclei.

Proton: hydrogen nuclei (one proton, no neutron)

Alpha particle: helium nuclei (two protons, two neutrons).

Deuterium: isotope of hydrogen ion (one proton, one neutron).

Tritium: isotope of hydrogen ion (one proton, two neutrons).

Helium-3: helium nuclei (two protons, one neutron). Isotope of alpha particle.

Charged particle: particle with net electrical charge. For example, ions and electrons.

Neutron: subatomic particle that has no electrical charge.

Nuclear fusion: reaction where light ions merge to form heavier ions. For example, hydrogen ions combine to form helium in stars.

Bremmstrahlung radiation and synchrotron radiation: types of electromagnetic radiation resulting from hot, relativistic electrons travelling in electrical and magnetic fields.

Fusion fuel: the particles that undergo fusion reactions (reactants). For example, deuterium and tritium ions.

Fusion product: the resulting particles after the fusion reaction. For example, neutrons and helium ions.

Thermonuclear: high temperature conditions appropriate for fusion nuclear reactions.

Triple product: a number that represents the performance level of a thermonuclear fusion energy concept. The number is the product of the plasma density, the plasma temperature, and the energy confinement time.

Lawson criterion: threshold value of triple product to have net energy gain.

Fusion energy gain: (multiple possible definitions) ratio of fusion energy produced divided by energy input. The energy input can be the energy required to heat the fuel, the wall plug energy, etc.:

Self-heating regime or alpha heating regime: temperature regime where energy from alpha particles produced from fusion reactions begins to heat the plasma internally.

Breakeven (scientific): fusion energy divided by heating energy.

Breakeven (engineering): fusion energy divided by wall plug energy.

Ignition or burning regime: when heating energy from alpha particles equals or exceeds radiation losses.

Self-sustained reactor: regime when there is no need for external energy input, i.e. when the electrical power produced by the reactor is sufficient, when recirculated back to the input, to produce the fusion conditions.

Power: energy divided by time; or equivalently, energy multiplied by frequency.

Propellant: the particles that serve as working material for a rocket exhaust to produce thrust.

Thrust: the force of the propellant on the rocket.

Specific impulse: the exhaust velocity of the propellant divided by a constant, the gravitational acceleration of Earth at sea level.

DeltaV or deltavee: increment in velocity from exhaust of propellant.

Specific power: (multiple possible definitions) power divided by mass. For example, thrust power divided by rocket engine mass.

List of References

[1] Yamada M., Russell K., Ji H., “Magnetic reconnection”, Rev. Mod. Phys., 82, 603 (2010).

[2] Ono Y., Tanabe H., Yamada K., et al., “High power heating of magnetic reconnection in merging tokamak experiments”, Phys. Plasmas, 22, 055708 (2015).

[3] Brown M. R., Gelber K. D., Mebratu M., “Taylor State Merging at SSX: Experiment and Simulation”, manuscript under review (2019).

[4] Bellan P. M., “Spontaneous, Three-Dimensional, Constant-Energy Implosion of Magnetic Mirror Fields”, Phys. Rev. Lett., 43, 12, (1979).

[5] Bellan P. M., “Traveling mirror compressor delay line with nonconstant capacitance.”, Phys. Fluids, 24, 11 (1981).

[6] Cothran C. D., Brown M. R., Gray T., et al, “Observation of a Helical Self-Organized State in a Compact Toroidal Plasma”, Phys. Rev. Lett., 103, 215002 (2009).

[7] Gray T., Brown M. R., Dandurand D., “Observation of a Relaxed Plasma State in a Quasi-Infinite Cylinder”, Phys. Rev. Lett., 110, 085002 (2013).

[8] Lavine E. S., “The Evolution and Dynamics of Magnetized Plasma Jets in the MOCHI.LabJet Experiment”, Ch. 6, PhD Thesis, Aeronautics & Astronautics, Univ. Washington, (2018).

[9] Lavine E. S., You S., “Observation of a plectonemic configuration in a stable magnetized plasma jet”, manuscript in preparation, (2020).

[10] Taylor J. B., “Relaxation and magnetic reconnection in plasmas”, Rev. Mod. Phys., 58, 741 (1986).

[11] You S., von der Linden J., Lavine E. S, et al., “The Mochi LabJet Experiment for Measurements of Canonical Helicity Injection in a Laboratory Astrophysical Jet”, Astrophys. J. Suppl. S., 236, 29 (2018).

[12] Gryaznevich M., Tokamak Energy team, Tendler M., Rozhansky V., Goncharov P., Kravchuk A., “Faster fusion: ST40, engineering, commissioning, first results”, AIP Conference Proceedings 2179:1, 020008, (2019).

[13] Boles T. C., White J. H., Cozzarelli, “Structure of plectonemically supercoiled DNA”, J. Molecular Biology, 213, 4, (1990).

[14] Artsimovich L., Controlled Thermonuclear Reactions, 2nd Ed., Fitzmagiz, Moscow, 1963.

[15] Haught A., Polk D. H., Fader W. J., “Magnetic field confinement of laser irradiated solid particle plasmas”, Phys. Fluids, 13, 11 (1970) 2842.

[16] Moir R. W., “Chapter 5: Direct Energy Conversion in Fusion Reactions”, in Considine D. M., Energy Technology Handbook, McGraw-Hill, NY, pp. 150-154, ISBN: 978-0070124301, 1977.

[17] Oliphant T. A., Ribe F. L., Coultas T. A., “Direct conversion of thermonuclear plasma energy by high magnetic compression and expansion”, Nuclear Fusion, 13, 529 (1973).

[18] Rosenbluth M. N. and Bussac M. N., “MHD stability of spheromak”, Nuclear Fusion, 19, 4 (1979).

[19] Bellan P. M., Spheromaks: a practical application of plasma self-organization, Imperial College Press, 2000, ISBN 978-1-86094-141-2.

[20] Bondeson A., Marklin G., An Z. G., Chen H. H., Lee Y. C., Liu C. S., “Tilting instability of a cylindrical spheromak”, Phys. Fluids, 24, 1682 (1981).

[21] Finn J. M., Manheimer W., Ott E., “Spheromak tilting instability in cylindrical geometry”, Phys. Fluids, 24, 1336 (1981).

[22] Yoon Y. D., Bellan P. M., “Fast ion heating in transient collisionless magnetic reconnection via an intrinsic stochastic mechanism”, Astrophys. J. Lett., 868:L31 (2018).

[23] Yoon Y. D, Bellan P. M., “Kinetic validation of the stochastic ion heating mechanism in collisionless magnetic reconnection”, Astrophys. J. Lett., 887:L29 (2019).

[24] Shibata K., Tanuma S., “Plasmoid-induced-reconnection and fractal reconnection”, Earth, Planets & Space, 53, 473-482 (2001).

[25] Matthaeus W. H., Ambrosiano J. J., and Goldstein M. L., “Particle Acceleration by Turbulent Magnetohydrodynamic Reconnection”, Phys. Rev. Lett. 53, 1449 (1984).

[26] Fiksel G., Almagri A. F., Chapman B. E., et al, “Mass-Dependent Ion Heating during Magnetic Reconnection in a Laboratory Plasma”, Phys. Rev. Lett. 103, 145002 (2009).

[27] Yoo J., Yamada M., Ji H., and Myers C. E., “Observation of Ion Acceleration and Heating during Collisionless Magnetic Reconnection in a Laboratory Plasma”, Phys. Rev. Lett. 110, 215007 (2013).

[28] Ono Y., Tanabe H., Hayashi Y., Ii T., Narushima Y., Yamada T., Inomoto M., Cheng C. Z., “Ion and electron heating characteristics of magnetic reconnection in a two flux loop merging experiment”, Physical Review Letters, 107, 185001 (2011).

[29] Woltjer L., “On hydromagnetic equilibrium”, Proc. Nat. Acad. Sci., 44, 9 (1958).

[30] Shumlak U., Chadney J., Golingo R. P., et al., “The sheared-flow stabilized Z-pinch”, Trans. Fusion Sci. Techn., 61, 119 (2012).

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A method for fusion energy generation comprising:
forming a plurality of magnetic plectonemes from a plurality of plasma sources;
merging the plurality of magnetic plectonemes into a single magnetic plectoneme;
compressing the single magnetic plectoneme to provide ignited plasma; and,
exhausting the ignited plasma.

2. The method according to claim 1, wherein merging comprises heating the single magnetic plectoneme to a high temperature by reconnection heating.

3. The method according to claim 2, wherein merging comprises heating the single magnetic plectoneme to a self-heating regime.

4. The method according to claim 1, wherein compressing is performed with constant energy compression.

5. The method according to claim 1, wherein each plasma source in the plurality of plasma sources produces one magnetic plectoneme.

6. The method according to claim 1, further comprising mixing the ignited plasma with cooler propellant.

7. The method according to claim 1, wherein electrically driven magnetic coils provide magnetic energy for: forming the plurality of magnetic plectonemes, merging the plurality of magnetic plectonemes, and compressing the single magnetic plectoneme.

8. The method according to claim 1, wherein fusion energy generation is performed by a fusion generation apparatus having an interior, wherein the interior comprises: a converging section, a stagnation section, and a diverging section.

9. The method according to claim 8, wherein electrically driven magnetic coils are disposed around the interior and the electrically driven magnetic coils provide magnetic energy for: forming the plurality of magnetic plectonemes, merging the plurality of magnetic plectonemes, and compressing the single magnetic plectoneme.

10. A method for fusion-augmented electric thrust comprising the method of claim 1, wherein the method produces charged particles from the ignited plasma, and the method further comprises converting the charged particles to propulsive power.

11. A method for fusion propulsion comprising the method of claim 1, wherein the method produces charged particles from the ignited plasma and the method further comprises:
generating auxiliary electric energy from an auxiliary power source;
coupling the auxiliary electric energy to a power management apparatus;
electrically driving the plurality of plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme;
converting a first portion of the charged particles to propulsive power;
converting a second portion of the charged particles to electric energy; and
coupling the electric energy from the charged particles to the power management apparatus.

12. A method for fusion propulsion comprising the method of claim 1, wherein the method produces charged particles from the ignited plasma and also produces neutrons and Bremmstrahlung radiation, and the method further comprises:
generating auxiliary electric energy from an auxiliary power source;
coupling the auxiliary electric energy to a power management apparatus;
electrically driving the plurality of plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme;
converting at least a portion of the charged particles to propulsive power; and
performing at least one set of the following two sets of steps:
set 1: converting thermal energy from the neutrons to neutron-based electric energy and coupling the neutron-based electric energy to the power management apparatus; and,
set 2: converting thermal energy from the Bremmstrahlung radiation to Bremmstrahlung-based electric energy and coupling the Bremmstrahlung-based electric energy to the power management apparatus.

13. A method for fusion propulsion and power generation comprising the method of claim 1, wherein the method produces charged particles from the ignited plasma and the method further comprises:
converting a first portion of the charged particles to propulsive power;
converting a second portion of the charged particles to electric energy;
coupling the electric energy to a power management apparatus;
electrically driving the plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme; and,
providing electric energy from the power management apparatus to a power grid.

14. A method for fusion propulsion comprising the method of claim 1, wherein the method produces charged particles from the ignited plasma and also produces neutrons and Bremmstrahlung radiation, and the method further comprises:
converting a first portion of the charged particles to propulsive power;
performing at least one set of the following two sets of steps:
set 1: converting thermal energy from the neutrons to neutron-based electric energy and coupling the neutron-based electric energy to a power management apparatus; and,
set 2: converting thermal energy from the Bremmstrahlung radiation to Bremmstrahlung-based electric energy and coupling the Bremmstrahlung-based electric energy to the power management apparatus;
electrically driving the plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme; and,
providing electric energy from the power management apparatus to a power grid.

15. A method for fusion-augmented electrical power generation comprising the method of claim 1, wherein the method produces charged particles from the ignited plasma and also produces neutrons and Bremmstrahlung radiation and the method further comprises:
coupling auxiliary electric energy to a power management apparatus from an auxiliary power supply;
converting a first portion of the charged particles to electric energy;
coupling the electric energy to the power management apparatus;
electrically driving the plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme;
providing electric energy from the power management apparatus to a power grid;
performing at least one set of the following three sets of steps: and
set 1: converting thermal energy from the neutrons to neutron-based electric energy and coupling the neutron-based electric energy to the power management apparatus; and,
set 2: converting thermal energy from the Bremmstrahlung radiation to Bremmstrahlung-based electric energy and coupling the Bremmstrahlung-based electric energy to the power management apparatus; and
set 3: converting thermal energy from the charged particles to charged particle-based electric energy and coupling the charged particle-based electric energy to the power management apparatus.

16. A method for self-sustained electrical power generation comprising the method of claim 1, wherein the method produces charged particles from the ignited plasma and also produces neutrons and Bremmstrahlung radiation and the method further comprises:
converting a first portion of the charged particles to electric energy;
coupling the electric energy to a power management apparatus;
electrically driving the plasma sources from electric energy provided by the power management apparatus;
electrically driving magnetic sources from electric energy provided by the power management apparatus to provide magnetic energy for: the forming of the plurality of magnetic plectonemes, the merging of the plurality of magnetic plectonemes and the compressing of the single magnetic plectoneme;
providing electric energy from the power management apparatus to a power grid; and
performing at least one set of the following three sets of steps:
set 1: converting thermal energy from the neutrons to neutron-based electric energy and coupling the neutron-based electric energy to the power management apparatus; and,
set 2: converting thermal energy from the Bremmstrahlung radiation to Bremmstrahlung-based electric energy and coupling the Bremmstrahlung-based electric energy to the power management apparatus; and
set 3: converting thermal energy from the charged particles to charged particle-based electric energy and coupling the charged particle-based electric energy to the power management apparatus.

17. A fusion drive comprising:
a mounting structure having a mounting end, and an exhaust end;
an interior disposed within the mounting structure, wherein the interior is disposed between the mounting end and the exhaust end, wherein the interior is defined by a first wall and the interior comprises:
a tapered cylindrical converging section disposed near the mounting end,
a tapered cylindrical diverging section disposed near the exhaust end;
and a cylindrical stagnation section disposed between the tapered cylindrical converging section and the tapered cylindrical converging section;
a blanket disposed around at least a portion of the interior
a plurality of plasma sources mounted at the mounting end, wherein the plurality of plasma sources generate a plurality of magnetic plectonemes and wherein each plasma source is configured to form at least one magnetic plectoneme within the tapered cylindrical converging section;
a plurality of magnetic coils disposed around at least a portion of the interior, wherein the plurality of magnetic coils are configured to generate magnetic fields to aid in merging the plurality of magnetic plectonemes to form a single magnetic plectoneme and to compress the single magnetic plectoneme to ignition; and
a shield disposed around at least a portion of the plurality of magnetic coils.

18. The fusion drive according to claim 17, wherein the plurality of magnetic coils are configured to generate magnetic fields to merge the plurality of magnetic plectonemes by performing reconnection heating of the plurality of magnetic plectonemes.

19. The fusion drive according to claim 17, wherein the plurality of magnetic coils are configured to generate magnetic fields to compress the single magnetic plectoneme by performing constant energy compression on the single magnetic plectoneme.

20. The fusion drive according to claim 17, wherein the plurality of plasma sources comprise a plurality of triple-electrode magnetized plasma guns.

21. The fusion drive according to claim 17, wherein individual sources of the plurality of plasma sources are arranged in a circular pattern at the mounting end.

22. The fusion drive according to claim 17, wherein individual sources of the plurality of plasma sources are oriented to direct individual magnetic plectonemes of the plurality of magnetic plectonemes to a common focal point.

23. The fusion drive according to claim 17 is configured for pulsed operation.

24. The fusion drive according to claim 17, wherein the exhaust end is capped.

25. The fusion drive according to claim 17, wherein the exhaust end is uncapped.

26. A space propulsion drive comprising the fusion drive according to claim 17, wherein the fusion drive is configured to produce plasma exhausted from the exhaust end against a diverging section of magnetic fields generated by the plurality of magnetic coils to produce thrust.

27. A space propulsion drive comprising the fusion drive according to claim 17, wherein the fusion drive is configured to mix plasma exhausted from the exhaust end with at least one of cooler plasma or neutral gas to produce thrust.

28. An electric power generator comprising the fusion drive according to claim 17, wherein the cylindrical stagnation section has a length to carry burning plasma in a peristaltic fashion until all energy is dissipated and fusion energy is output from the fusion drive in form of neutron kinetic energy, electromagnetic energy and charged particle energy and at least one of these forms of energy is converted to electrical energy.

29. A propulsion drive comprising the fusion drive according to claim 17, wherein the propulsion drive further comprises:
a propulsion conversion apparatus producing thrust from plasma exhausted at the exhaust end;
an auxiliary power source; and
a power management apparatus electrically coupled to the auxiliary power source,
wherein the power management apparatus provides electrical energy to the plurality of plasma sources and the plurality of magnetic coils.

30. The propulsion drive according to claim 29, further comprising a thermal power conversion apparatus, a direct power conversion apparatus, or a thermal power conversion apparatus and a direct power conversion apparatus, wherein the thermal power conversion apparatus converts thermal energy from the first wall, or the blanket or the first wall and the blanket to electrical energy, wherein the thermal power conversion apparatus is coupled to the power management apparatus; and wherein the direct power conversion apparatus converts energy from plasma exhausted at the exhaust end to electrical energy, wherein the direct power conversion apparatus is coupled to the power management apparatus.

31. A propulsion drive comprising the fusion drive according to claim 17, wherein the propulsion drive further comprises:
a propulsion conversion apparatus producing thrust from plasma exhausted at the exhaust end;
a power management apparatus providing electrical energy to the plurality of plasma sources and the plurality of magnetic coils; and
a thermal power conversion apparatus, a direct power conversion apparatus, or a thermal power conversion apparatus and a direct power conversion apparatus, wherein the thermal power conversion apparatus converts thermal energy from the first wall, or the blanket or the first wall and the blanket to electrical energy, wherein the thermal power conversion apparatus is coupled to the power management apparatus; and wherein the direct power conversion apparatus converts energy from plasma exhausted at the exhaust end to electrical energy, wherein the direct power conversion apparatus is coupled to the power management apparatus.

32. A propulsion drive and power generator comprising the fusion drive according to claim 17, wherein the propulsion drive and power generator further comprises:
a propulsion conversion apparatus producing thrust from plasma exhausted at the exhaust end;
a power management apparatus, wherein the power management apparatus provides electrical energy to the plurality of plasma sources and the plurality of magnetic coils and provides electrical energy to a power grid; and
a thermal power conversion apparatus, a direct power conversion apparatus, or a thermal power conversion apparatus and a direct power conversion apparatus, wherein the thermal power conversion apparatus converts thermal energy from the first wall, or the blanket or the first wall and the blanket to electrical energy, wherein the thermal power conversion apparatus is coupled to the power management apparatus; and wherein the direct power conversion apparatus converts energy from plasma exhausted at the exhaust end to electrical energy, wherein the direct power conversion apparatus is coupled to the power management apparatus.

33. The propulsion drive and power generator according to claim 32, further comprising an auxiliary power source electrically coupled to the power management apparatus.

34. A power generator comprising the fusion drive according to claim 17, wherein the power generator further comprises:
a power management apparatus providing electrical energy to the plurality of plasma sources and the plurality of magnetic coils and provides electrical energy to a power grid; and
a thermal power conversion apparatus, a direct power conversion apparatus, or a thermal power conversion apparatus and a direct power conversion apparatus, wherein the thermal power conversion apparatus converts thermal energy from the first wall, or the blanket or the first wall and the blanket to electrical energy, wherein the thermal power conversion apparatus is coupled to the power management apparatus; and wherein the direct power conversion apparatus converts energy from plasma exhausted at the exhaust end to electrical energy, wherein the direct power conversion apparatus is coupled to the power management apparatus.

35. The power generator according to claim 34, further comprising an auxiliary power source electrically coupled to the power management apparatus.

36. A system for a fusion drive comprising:
a converging volume, wherein a plurality of magnetic plectonemes are formed within the converging volume,
a stagnation volume having a first end and a second end, wherein the first end of the stagnation volume is coupled to the converging volume, wherein the plurality of magnetic plectonemes are merged into a single magnetic plectoneme at the first end of the stagnation volume and wherein the single magnetic plectoneme is compressed within the stagnation volume to provide ignited plasma for exhaustion at the second end of the stagnation volume; and,
a diverging volume coupled to the second end of the stagnation volume, wherein the ignited plasma is exhausted through the diverging volume.

37. The system according to claim 36, wherein the plurality of magnetic plectonemes are merged into a single magnetic plectoneme by heating the single magnetic plectoneme to a high temperature with reconnection heating.

38. The system according to claim 36, wherein the single magnetic plectoneme is compressed within the stagnation volume by constant energy compression.

39. The system according to claim 36, wherein the system is configured to mix cooler propellant with ignited plasma within the diverging volume.

40. The system according to claim 36, further comprising magnetic coils disposed around at least a portion of the converging volume, the stagnation volume, and the diverging volume.

41. The system according to claim 36, wherein the converging volume has a first end and a second end, wherein the second end of the converging volume is coupled to the first end of the stagnation volume, and wherein the system further comprises a plurality of plasma sources disposed at the first end of the converging volume.
